(19) United States
(12) Patent Application Publication
(10) Pub. No.: US 2025/0390990 A1
(43) Pub. Date: Dec. 25, 2025

(54) TARGET-AWARE IMAGE-BASED DENOISING METHOD AND SYSTEM CAPABLE OF INVERSE RENDERING

(71) Applicant: GWANGJU INSTITUTE OF SCIENCE AND TECHNOLOGY, Gwangju (KR)

(72) Inventors: Bochang MOON, Gwangju (KR); Jeongmin GU, Gwangju (KR); Jonghee BACK, Gwangju (KR)

(73) Assignee: GWANGJU INSTITUTE OF SCIENCE AND TECHNOLOGY, Gwangju (KR)

(21) Appl. No.: 19/038,937

(22) Filed: Jan. 28, 2025

(30) Foreign Application Priority Data
Jun. 19, 2024 (KR) 10-2024-0079520

(51) Int. Cl. G06T 5/70; G06T 7/90

(52) U.S. Cl. CPC G06T 5/70; G06T 7/90; G06T 2207/20182

(57) ABSTRACT

A denoising method using a denoising system is provided. The denoising method including: receiving a target image; generating a rendered image corresponding to the target image based on pre-provided initial scene parameters; calculating denoising weights based on the target image, and generating a refined image by removing noise from at least one of the rendered image and a gradient of a loss for the rendered image based on the denoising weights; and calculating a loss between the target image and the refined image, and updating the scene parameters based on a gradient of the calculated loss.

### CROSS REFERENCE TO RELATED APPLICATION

The present application claims priority to Korean Patent Application No. 10-2024-0079520, filed on Jun. 19, 2024, the entire contents of which is incorporated herein for all purposes by this reference.

### BACKGROUND

### Field

The present application relates to a target-aware image-based denoising method and system capable of inverse rendering.

### Description of Government-Sponsored Research

The present invention was carried out with support from the national research and development project, with the unique project identification number being 1711194523 and the project number being 00207939. The project related to the present invention is supervised by the Ministry of Science and ICT, and managed by the National Research Foundation of Korea (NRF). The research project is titled “Basic Individual Research (Ministry of Science and ICT) Project,” and the research project is named “Deep Learning-Based Denoising of Realistic Rendered Images Using Incomplete Datasets.” The project executing institution is Gwangju Institute of Science and Technology, and the research period is from Mar. 1, 2023, to Feb. 28, 2026.

In addition, the present invention was carried out with support from the national research and development project, with the unique project identification number being 1711193555 and the project number being 2022-0-00566-002. The project related to the present invention is supervised by the Ministry of Science and ICT, and managed by the Institute of Information and Communications Technology Planning and Evaluation (IITP). The research project is titled “Core Technology Development Project for Immersive Content,” and the research project is named “Development of Object Media Processing Technology for Multi-Source Image.” The project executing institution is the Korea Electronics Technology Institute (KETI), and the research period is from Apr. 1, 2022, to Dec. 31, 2025.

### Description of the Related Art

A rendering technique such as Monte Carlo rendering based on path tracing has been established as the standard solution for scenarios requiring realistic images, as the rendering technique can accurately simulate various physically based light transport effects in three-dimensional virtual scenes.

These rendering techniques have evolved from conventional rasterization techniques to ray tracing and path tracing techniques. In particular, these rendering techniques enable inverse rendering through simulations such as a radiance function, based on two-dimensional images, which allows for the inference of various scene parameters from the two-dimensional images.

However, in Monte Carlo rendering techniques, as the number of samples per pixel (SPP) required for calculation during the rendering process increases, higher-quality images that resemble realism may be acquired. Nevertheless, the computing resources and time consumption required for the rendering process also increase drastically. Accordingly, rendering is performed using an appropriate number of samples per pixel. Accordingly, there is a need for a solution to remove noise occurred by the reduction in the number of samples per pixel and to acquire a high-quality image as much as possible.

### SUMMARY

The present invention relates to a denoising method and system for suppressing bias during the process of removing noise from a rendered image and removing the noise.

In addition, the present invention relates to a denoising method and system for more accurately acquiring scene parameters estimated from an image and improving the quality of the scene parameters and rendered image.

To solve the aforementioned objects, there is provided a denoising method using a denoising system, according to the present invention. The denoising method may include: receiving a target image; generating a rendered image corresponding to the target image based on pre-provided initial scene parameters; calculating denoising weights based on the target image, and generating a refined image by removing noise from at least one of the rendered image and a gradient of a loss for the rendered image based on the denoising weights; and calculating a loss between the target image and the refined image, and updating the scene parameters based on a gradient of the calculated loss.

In addition, there is provided a denoising system, according to the present invention. The denoising system may include: an input unit configured to receive a target image; and a control unit configured to generate a rendered image corresponding to the target image based on pre-provided initial scene parameters, in which the control unit may calculate denoising weights based on the target image, generate a refined image by removing noise from at least one of the rendered image and a gradient of a loss for the rendered image based on the denoising weights, calculate a loss between the target image and the refined image, and update the scene parameters based on a gradient of the calculated loss.

In addition, there is provided a program stored on a computer-readable recording medium, and executed by one or more processes in an electronic device in a denoising method using a denoising system, according to the present invention. The program may include instructions to allow the program to perform: receiving a target image; generating a rendered image corresponding to the target image based on pre-provided initial scene parameters; calculating denoising weights based on the target image, and generating a refined image by removing noise from at least one of the rendered image and a gradient of a loss for the rendered image based on the denoising weights; and calculating a loss between the target image and the refined image, and updating the scene parameters based on a gradient of the calculated loss.

According to various embodiments of the present invention, the denoising method and system may suppress the bias in the process of removing noise from the rendered image by removing noise from the rendered image using denoising weights calculated based on the target image, thus removing noise from the rendered image.

In addition, according to various embodiments of the present invention, the denoising method and system may acquire the scene parameters estimated from the image more accurately by updating the scene parameters through the inverse rendering of the noise-removed image. By repeatedly performing the rendering and inverse rendering processes, the system can improve the quality of both the scene parameters and the rendered image.

### BRIEF DESCRIPTION OF THE DRAWINGS

FIG. 1 illustrates the rendering and inverse rendering processes of a denoising system according to the present invention.

FIG. 2 illustrates an embodiment of a refined image based on constants and linear regression.

FIG. 3 illustrates an embodiment of generating a refined image based on a target image.

FIG. 4 illustrates a denoising system according to the present invention.

FIG. 5 illustrates an embodiment of optimizing a refined image.

FIG. 6 is a flowchart illustrating a denoising method according to the present invention.

FIG. 7 is a block diagram illustrating the structure of a computing device performing a denoising method of the present invention.

### DETAILED DESCRIPTION OF EMBODIMENTS

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

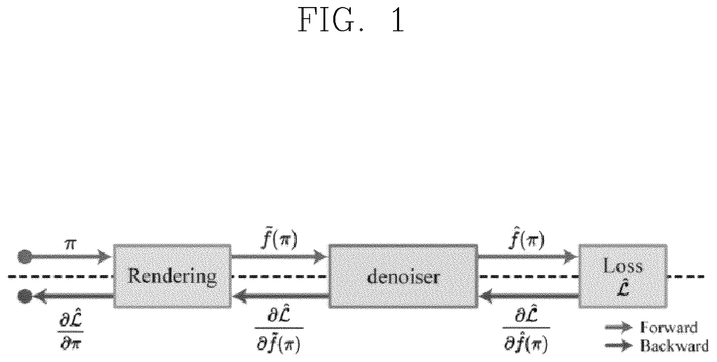

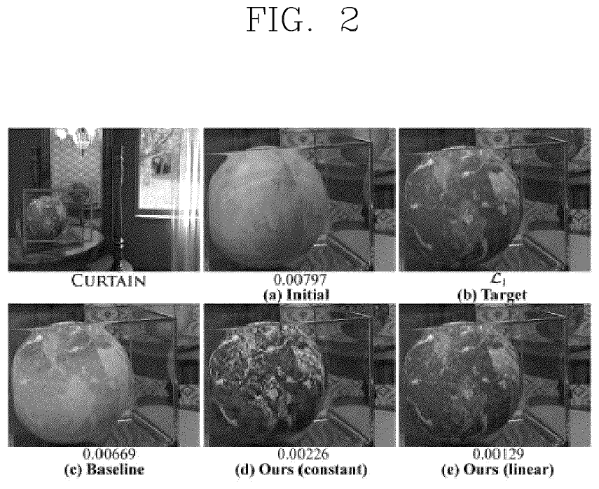

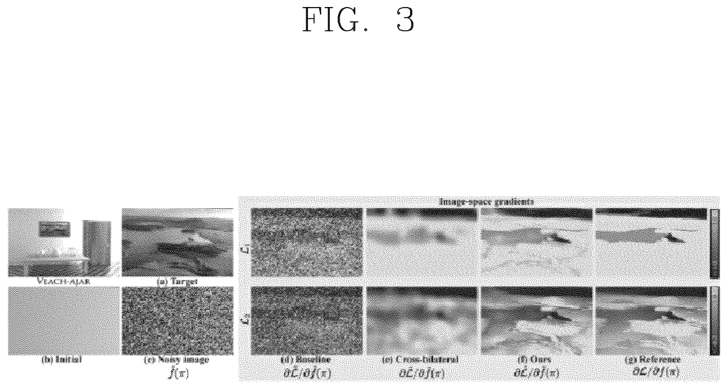

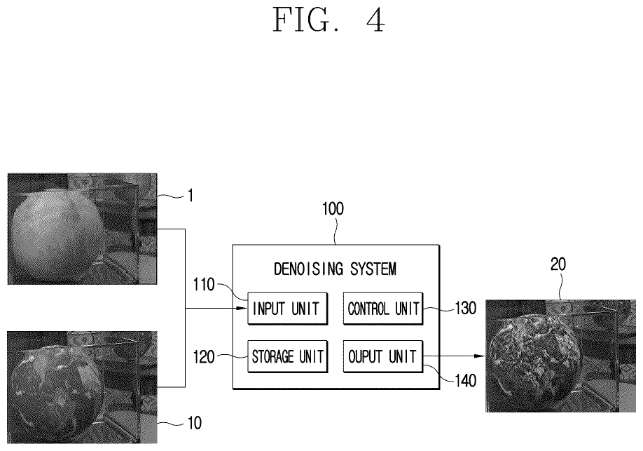

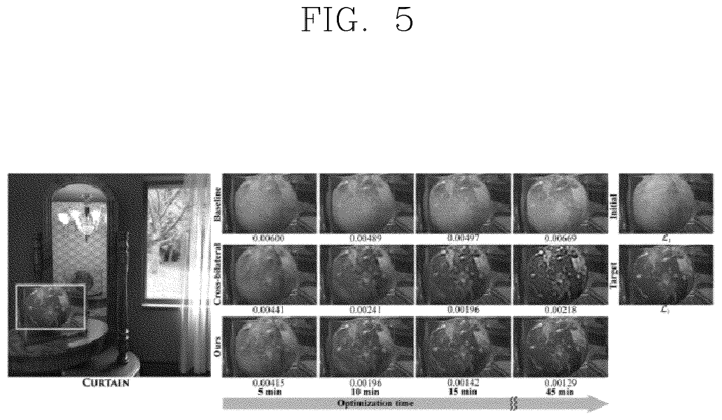

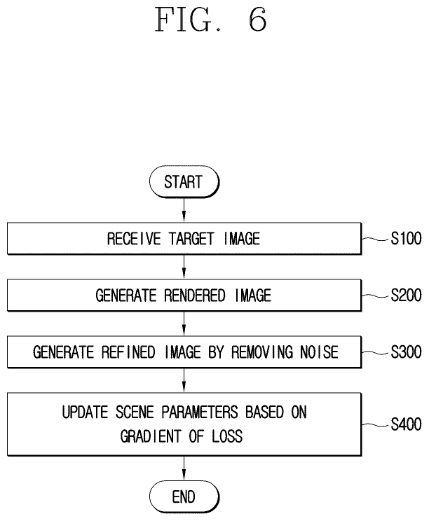

FIG. 1 illustrates rendering and inverse rendering processes of a denoising system according to the present invention. FIG. 2 illustrates an embodiment of a refined image based on constants and linear regression. FIG. 3 illustrates an embodiment of generating a refined image based on a target image. FIG. 4 illustrates a denoising system according to the present invention. FIG. 5 illustrates an embodiment of optimizing a refined image. FIG. 6 is a flowchart illustrating a denoising method according to the present invention.

A denoising system 100 according to the present invention may receive a target image (or subject image) and generate a rendered image corresponding to the target image based on pre-provided initial scene parameters.

With reference to FIG. 1 in this regard, the denoising system 100 may calculate denoising weights based on the target image and remove noise from the rendered image based on the denoising weights. In this case, the noise-removed rendered image may be referred to as a refined image.

In addition, the denoising system 100 may calculate a loss between the rendered image and the refined image, and update scene parameters based on the gradient of the calculated loss. That is, the denoising system 100 may perform inverse rendering on the rendered image (or refined image) to update the scene parameters.

In this case, the scene parameters may include information on a three-dimensional space constructed through inverse rendering from the rendered image. For example, the scene parameters may include information related to a camera position, camera orientation, an object position, object orientation, light sources, and the like.

Accordingly, the rendered image may be a two-dimensional image generated based on the scene parameters, and the scene parameters generated through inverse rendering from the rendered image may include information on a three-dimensional space.

To this end, the denoising system 100 may perform local regression on information related to the inverse rendering of the rendered image to generate denoising weights for generating the refined image.

Specifically, the denoising system 100 may locally approximate the refined image corresponding to the rendered image using a linear function (e.g., a first-order Taylor polynomial) for the pixel colors of the target image.

In an embodiment, the denoising system 100 may approximate the rendered image according to Equation 1 below.

$${f}_{i} ( π ) \approx {f}_{c} ( π ) + {f}_{c}^{′} ( π ) ( {I}_{i} - {I}_{c} ) \qquad Equation 1$$

fᵢ(π) may represent a color at an arbitrary pixel of the rendered image (or refined image), f_{c}(π) may represent a color at a central pixel of the rendered image, and f′_{c}(π) may represent a result of a first derivative of the color at the central pixel of the rendered image based on the scene parameters. In addition, “I” may represent the target image (or subject image), “c” may represent a central pixel position of both the rendered image and the target image, and “i” may represent an arbitrary pixel position of both the rendered image and the target image. Here, π may represent the scene parameters.

In this case, the denoising system 100 may independently remove noise for each color channel of the rendered image. Accordingly, the color of the rendered image (e.g., the color at an arbitrary pixel and the color at the central pixel) may be processed as a one-dimensional value.

In this regard, the denoising system 100 may use a weighted least-squares objective function, based on the pixel colors of each of the target image and the rendered image, along with the denoising weight, to estimate the color at the central pixel of the refined image as well as the result of the first derivative of the color at the central pixel of the refined image.

In an embodiment, the denoising system 100 may estimate the color at the central pixel of the refined image as well as the result of the first derivative of the color at the central pixel of the refined image through Equation 2 below.

$$[ \begin{matrix}{\hat{α}}_{c} \\ {\hat{β}}_{c}\end{matrix} ] = {arg min}_{{α}_{c} , {β}_{c}} {\sum }_{i ∈ {Ω}_{c}} {w}_{i \vert c} {‖ {\tilde{f}}_{i} ( π ) - {α}_{c} - {β}_{c} ( {I}_{i} - {I}_{c} ) ‖}^{2} \qquad Equation 2$$

Here, \hat{α}_{c} may represent an estimated value of the color at the central pixel of the refined image, \hat{β}_{c} may represent an estimated value of the result of the first derivative of the color at the central pixel of the refined image, and α_{c} and β_{c} may represent true values of \hat{α}_{c} and \hat{β}_{c}. In addition, Wile may represent a denoising weight, \tilde{f}ᵢ(π) may represent a rendered image in which noise exits, and Ω_{c} may be a window of a predetermined size with respect to the central pixel.

In this case, the denoising weight may be determined to represent the importance according to the squared error of the color at an arbitrary pixel of the target image. In an embodiment, the denoising system 100 may define the weight using Equation 3 below.

$${w}_{i \vert c} = exp ( \frac{{‖ {log}_{e} ( {I}_{i} + 1 ) - {log}_{e} ( {I}_{c} + 1 ) ‖}^{2}}{2 {( {b}^{I} )}^{2}} ) \qquad Equation 3$$

Here, b^{I} may represent the bandwidth of the denoising weight. The bandwidth of the denoising weight may be set differently depending on the embodiment, and for example, may be 0.1.

Such a denoising weight may vary depending on the color range of the target image. In an embodiment, when the color range in the target image is high dynamic range (HDR), the denoising weight may be calculated through a logarithmic conversion as shown in Equation 3.

Accordingly, the denoising system 100 may calculate optimal coefficients for approximating the rendered image to the target image through a closed-form solution, such as the normal equation shown in Equation 2 (e.g., the estimated value of the color at the central pixel of the refined image and the estimated value of the result of the first derivative of the color at the central pixel of the refined image).

In this case, the denoising system 100 may also calculate the optimal coefficients for approximating the rendered image in a form such as Equation 4 below, depending on the embodiment.

$$[ \begin{matrix}{\hat{α}}_{c} \\ {\hat{β}}_{c}\end{matrix} ] = {( {X}^{T} WX )}^{- 1} {X}^{T} WY \qquad Equation 4$$

Here, “X” is a design matrix with twice the size of window of a predetermined size with respect to the central pixel (e.g., |Ω_{c}|×2), and a value of an i-th row of “X” may be [1, Iᵢ−I_{c}]. In addition, “W” is a diagonal matrix with a squared size of window of a predetermined size with respect to the central pixel (e.g., |Ω_{c}|×|Ω_{c}|), and an i-th element of “W” may be the denoising weight according to Equation 3. In addition, “Y” is a column vector with a size of window of a predetermined size with respect to the central pixel (e.g., |Ω_{c}|), and may have the value of the rendered image (e.g., \tilde{f}ᵢ(π)).

Therefore, the denoising system 100 may estimate the color of the central pixel with noise removed from the rendered image by calculating the solution to the normal equation for the central pixel and arbitrary pixels of the rendered image and target image, and based on this, estimate the refined image.

Subsequently, the denoising system 100 may calculate the loss for the noise-removed rendered image (or refined image) and the gradient of the loss for the noise-removed rendered image.

In an embodiment, the loss for the refined image may be represented as shown in Equation 5 below, and the gradient may be represented as shown in Equation 6 below.

$$L = {m}^{- 1} {‖ \hat{f} ( π ) - I ‖}_{p}^{p} \qquad Equation 5$$

Here, \hat{L} may represent a loss for the refined image, and \hat{f}(π) may represent the refined image. In this case, “m” may represent the number of pixels in the rendered image (or refined image), “p” may represent the order of the loss, and in one embodiment, the order may be 1.

$$\frac{\partial L}{\partial f ( π )} \qquad Equation 6$$

Meanwhile, the denoising system 100 may calculate the gradient of the loss for the rendered image according to the refined image. In an embodiment, the denoising system 100 may calculate the gradient of the loss for the rendered image (or the gradient of the loss for the rendered image according to the refined image) according to Equation 7 below.

$$\frac{\partial \hat{L}}{\partial \tilde{f} ( π )} = \frac{\partial \hat{L}}{\partial \tilde{f} ( π )} \frac{\partial \hat{f} ( π )}{\partial \tilde{f} ( π )} \qquad Equation 7$$

Here, \tilde{f}(π) may represent the rendered image. In this case, the rendered image may be an image rendered with a predetermined number of samples so that the rendered image is differentiable based on the scene parameters.

To this end, the denoising system 100 may calculate the refined image through a linear smoother for the rendered image. In an embodiment, the denoising system 100 may represent the refined image as shown in Equation 8 below.

$${\hat{f}}_{c} ( π ) = {α}_{c} = {{e}_{1}^{T} ( {X}^{T} WX )}^{- 1} {X}^{T} WY = {\sum }_{i ∈ {Ω}_{c}} {I}_{i \vert c} {\tilde{f}}_{i} ( π ) \qquad Equation 8$$

Here, \hat{f}_{c}(π) represents the color at the central pixel of the refined image, and

$${e}_{1}^{T}$$

is a predetermined coefficient, which may be set to [1, 0] in an embodiment. In addition, l_{i|c} may represent a denoising weight based on the target image. Such a denoising weight may be assigned a predetermined value based on the pixel color of the target image.

Further, the denoising system 100 may calculate the gradient of the loss for the rendered image at an arbitrary pixel based on Equation 8. In an embodiment, the denoising system 100 may represent the gradient of the loss for the rendered image at an arbitrary pixel as shown in Equation 9 below.

$$\begin{matrix}\frac{\partial \hat{L}}{\partial {\tilde{f}}_{i} ( π )} = \frac{\partial \hat{L}}{\partial \tilde{f} ( π )} \frac{\partial \hat{f} ( π )}{\partial {\tilde{f}}_{i} ( π )} \\ = {\sum }_{c ∈ {Ω}_{i}} \frac{\partial \hat{L}}{\partial {\hat{f}}_{c} ( π )} \frac{\partial {\hat{f}}_{c} ( π )}{\partial {\tilde{f}}_{i} ( π )} \\ = {\sum }_{c ∈ {Ω}_{i}} \frac{\partial \hat{L}}{\partial {\hat{f}}_{c} ( π )} {l}_{i \vert c}\end{matrix} \qquad Equation 9$$

Here, the denoising weight may be determined as a local average from the central pixel to an arbitrary pixel of the target image (or refined image).

Such a denoising weight may be applied to the gradient of the loss for both the refined image and the rendered image during the inverse rendering process.

Therefore, the denoising system 100 may update the scene parameters based on the gradient of the loss for the rendered image. That is, the denoising system 100 may calculate the gradient of the loss for the scene parameters using the chain rule based on the gradient of the loss for the rendered image, in cases where differentiation of the rendered image is possible based on the scene parameters. Accordingly, the optimal scene parameters that minimize the loss may be specified according to the gradient of the loss for the scene parameters.

Meanwhile, the denoising system 100 may remove (or mitigate) the bias arising during the process of removing noise from the rendered image, as well as the bias according to the gradient of the loss for the rendered image.

Specifically, when a second derivative of the rendered image is possible, the denoising system 100 may represent the second-order Taylor polynomial for the rendered image as shown in Equation 10 below.

$${f}_{i} ( π ) \approx {f}_{c} ( π ) + {f}_{c}^{′} ( π ) ( {I}_{i} - {I}_{c} ) + \frac{{f}_{c}^{″} ( π )}{2} {( {I}_{i} - {I}_{c} )}^{2} \qquad Equation 10$$

Accordingly, the denoising system 100 may calculate the bias in the process of removing noise from the rendered image as shown in Equation 11 below.

$$\begin{matrix}E [ {\hat{f}}_{c} ( π ) ] - {f}_{c} ( π ) = {\sum }_{i ∈ {Ω}_{c}} {l}_{i \vert c} E [ {\tilde{f}}_{i} ( π ) ] - {f}_{c} ( π ) \\ = {\sum }_{i ∈ {Ω}_{c}} {l}_{i \vert c} {f}_{i} ( π ) - {f}_{c} ( π )\end{matrix} \qquad Equation 11$$

Here, “E” may represent an expected value of a random variable. In addition, the denoising weight may be a value independent of the rendered image and may be a fixed value when there is no variation in the target image. That is, the expected value of the random variable for the denoising weight may be the same value as the denoising weight itself.

Accordingly, the denoising system 100 may calculate an approximate value for the bias in the process of removing noise from the rendered image, as shown in Equation 12 below.

$$E [ {\hat{f}}_{c} ( π ) ] - {f}_{c} ( π ) \approx {f}_{c} ( π ) {\sum }_{i ∈ {Ω}_{c}} {l}_{i \vert c} + {\sum }_{i ∈ {Ω}_{c}} {l}_{i \vert c} ( {I}_{i} - {I}_{c} ) + \frac{{f}_{c}^{″} ( π )}{2} {\sum }_{i ∈ {Ω}_{c}} {{l}_{i \vert c} ( {I}_{i} - {I}_{c} )}^{2} - {f}_{c} ( π ) \qquad Equation 12$$

In this regard, when the denoising system 100 removes noise from the rendered image by performing linear regression, the mathematical expression for the denoising weight may be calculated as shown in Equation 13 below.

$${\sum }_{i ∈ {Ω}_{c}} {l}_{i \vert c} = 1 \qquad Equation 13$$

$${\sum }_{i ∈ {Ω}_{c}} {l}_{i \vert c} ( {I}_{i} - {I}_{c} ) = 0$$

Therefore, the bias in the process of removing noise from the rendered image may be briefly represented as shown in Equation 14 below.

$$E [ {\hat{f}}_{c} ( π ) ] - {f}_{c} ( π ) \approx \frac{{f}_{c}^{″} ( π )}{2} {\sum }_{i ∈ {Ω}_{c}} {{l}_{i \vert c} ( {I}_{i} - {I}_{c} )}^{2} \qquad Equation 14$$

Such bias in the process of removing noise from the rendered image may provide an intuition for the noise removal bias that is unrelated to the first derivative of the rendered image when generating a refined image that is linearly correlated with the target image. That is, the bias in the process of removing noise from the rendered image may be represented as a linear function of the target image.

In addition, the temporal variation of the bias occurring in the process of removing noise from the rendered image may be understood as depending solely on the second derivative of the rendered image, since the denoising weight remains fixed over time.

Therefore, the bias occurring in the process of removing noise from the rendered image may decrease as the previously optimized scene parameters approach the ideal scene parameters that make the rendered image identical to the target image.

In this regard, as illustrated in FIG. 2, the denoising system 100 may also remove noise from the rendered image without performing linear regression, using denoising weights based on the target image (e.g., (d) constant). In this case, the denoising system 100 may be understood as approximating the rendered image using a constant function through zero-order regression. Unlike linear regression (e.g., (e) linear), a constant function cannot approximate a linear function, and thus the bias may vary depending on the first derivative (and the second derivative).

Meanwhile, as illustrated in FIG. 3, when the denoising system 100 applies a linear smoothing-based denoising system, including a cross-bilateral filter, the bias according to the gradient of the loss for the rendered image may be calculated as shown in Equation 15 below.

$$E [ \frac{\partial \hat{L}}{\partial {\tilde{f}}_{i} ( π )} ] - \frac{\partial L}{\partial {f}_{i} ( π )} = {\sum }_{c ∈ {Ω}_{i}} E [ \frac{\partial \hat{L}}{\partial {\hat{f}}_{c} ( π )} \frac{\partial {\hat{f}}_{c} ( π )}{\partial {\tilde{f}}_{i} ( π )} ] - \frac{\partial L}{\partial {f}_{i} ( π )} = {\sum }_{c ∈ {Ω}_{i}} E [ \frac{\partial \hat{L}}{\partial {\hat{f}}_{c} ( π )} ] {l}_{i \vert c} \frac{\partial L}{\partial {f}_{i} ( π )} \qquad Equation 15$$

In this regard, the denoising weight calculated in the process of removing noise from the rendered image is a weighted average calculated with respect to the gradient of the loss for the refined image, and thus the denoising weight may be understood to also affect the gradient of the loss for the rendered image.

Meanwhile, with reference to FIG. 4, the denoising system 100 may include an input unit 110, a storage unit 120, a control unit 130, and an output unit 140.

The input unit 110 may receive information necessary for the operation of the denoising system 100 according to the present invention as input. To this end, the input unit 110 may be connected to a separate input device, server, or external storage device via a wireless or wired network.

Accordingly, the input unit 110 may receive the target image from a separate input device, server, external storage device, or the like, and depending on the embodiment, may also receive the initial scene parameters.

The storage unit 120 may store information and instructions necessary for the operation of the denoising system 100 according to the present invention.

For example, the storage unit 120 may store the target image received through the input unit 110, and may also store the scene parameters, rendered image, and refined image generated by the control unit 130.

The control unit 130 may control the overall operation of the denoising system 100 according to the present invention.

For example, the control unit 130 may generate a rendered image based on the initial scene parameters, calculate denoising weights based on the target image, and generate a refined image by removing noise from the rendered image using the denoising weights.

In addition, the control unit 130 may repeatedly perform the process of calculating the loss between the target image and the refined image, updating the scene parameters based on the gradient of the calculated loss, generating a rendered image based on the updated scene parameters, and updating the scene parameters again by removing noise.

In this case, as illustrated in FIG. 5, the control unit 130 may repeatedly perform the update process for the scene parameters (or the noise removal process) for a predetermined number of iterations or for a predetermined time period. Alternatively, the control unit 130 may repeatedly perform the update process for the scene parameters (or the noise removal process) until the loss between the target image and the refined image satisfies a predetermined criterion.

The output unit 140 may output the information generated by the operation of the denoising system 100 according to the present invention. To this end, the output unit 140 may be connected to a separate visual output device, server, external storage device, or the like via a wireless or wired network.

Accordingly, the output unit 140 may output the target image, rendered image, and refined image through a separate output device, server, external storage device, or the like so that a user may visually identify the images. In addition, output unit 140 may also output information related to the scene parameters, loss, and the like.

Meanwhile, the denoising system 100 according to the present invention may remove noise from the rendered image that is rendered based on the scene parameters in accordance with the aforementioned denoising method.

That is, with reference to FIG. 6, the denoising system 100 may receive the target image (S100) and generate a rendered image corresponding to the target image based on the pre-provided initial scene parameters (S200).

Accordingly, the denoising system 100 may calculate denoising weights based on the target image and generate a refined image by removing noise from the rendered image based on the denoising weights (S300).

In this case, the denoising system 100 may calculate the loss between the target image and the refined image and update the scene parameters based on the gradient of the calculated loss (S400).

In addition, the denoising system 100 may remove noise from the rendered image by repeatedly performing the process of generating the rendered image based on the updated scene parameters, followed by updating the scene parameters.

With the configurations as described above, the denoising system 100 according to the present invention may suppress the bias in the process of removing noise from the rendered image by removing noise from the rendered image using denoising weights calculated based on the target image, thus removing noise from the rendered image.

In addition, the denoising system 100 according to the present invention may acquire the scene parameters estimated from the image more accurately by updating the scene parameters through inverse rendering of the noise-removed rendered image. By repeatedly performing the rendering and inverse rendering processes, the system can improve the quality of both the scene parameters and the rendered image.

Further, the denoising system 100 according to the present invention may be configured as a computing device and perform at least one function related to the aforementioned denoising method.

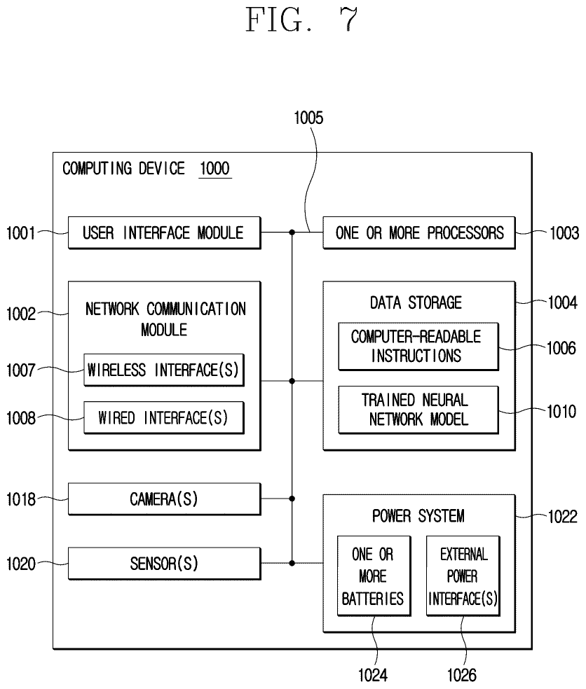

FIG. 7 is a block diagram illustrating the structure of a computing device performing a denoising method of the present invention.

The computing device 1000 may include a user interface module 1001, a network communication module 1002, one or more processors 1003, data storage 1004, one or more cameras 1018, one or more sensors 1020, and a power system 1022, all of which may be interconnected via a system bus, network, or other connection mechanism 1005.

The user interface module 1001 may be operable to transmit data to and/or receive data from external user input/output devices.

For example, in the present invention, receiving the target image (or subject image) by the denoising system 100 may performed by an external input using the user interface module. In this case, the user interface module 1001 may include a touchscreen, computer mouse, keyboard, keypad, touchpad, trackball, joystick, voice recognition module, or other similar devices.

In addition, the user interface module 1001 may also be configured to provide output to one or more user display devices, such as a cathode ray tube (CRT), liquid crystal display (LCD), light-emitting diode (LED), display using digital light processing (DLP) technology, or a printer.

The user interface module 1001 may also be configured to generate audible output using devices such as speakers, speaker jacks, audio output ports, audio output devices, earphones, and/or other similar devices.

The user interface module 1001 may further configured with one or more haptic devices capable of generating tactile output, such as vibration and/or other forms of output, detectable by touch and/or physical contact with the computing device 1000.

The network communication module 1002 may include one or more devices that provide one or more wireless interfaces 1007 and/or one or more wired interfaces 1008, which can be configured to communicate over a network.

In addition, the network communication module 1002 may be configured to provide secure and/or authenticated communication that is reliable.

The one or more processors 1003 may include one or more general-purpose processors and/or one or more special-purpose processors (e.g., digital signal processors, tensor processing units (TPUs), graphics processing units (GPUs), neural processing units (NPUs), application-specific integrated circuits (ASICs), or application-specific semiconductors, etc.). The one or more processors 1003 may be configured to execute computer-readable instructions 1006 included in the data storage 1004 and/or other commands described in the present specification.

As such an example, the inverse rendering algorithm described in the present specification may be executed on a neural processing unit (NPU) to enhance efficiency by performing data calculation processing with high speed and low power consumption.

The data storage 1004 may include one or more non-transitory computer-readable storage media that are readable and/or accessible by at least one of the one or more processors 1003.

The one or more computer-readable storage media may include volatile and/or non-volatile storage constituent elements, such as optical, magnetic, organic, or other memory or disk storage devices. In some examples, the data storage 1004 may be implemented using a single physical device (e.g., one optical, magnetic, organic, or other memory or disk storage device), whereas in other examples, the data storage 1004 may be implemented using two or more physical devices.

The data storage 1004 may include computer-readable instructions 1006 as well as additional data. The data storage 1004 may include storage necessary to perform at least part of the methods, scenarios, and technologies described in the present specification and/or at least part of the functions of the devices and networks.

The data storage 1004 may include, for example, storage for the neural network model 1010 to which the inverse rendering algorithm described in the present invention is applied and trained based thereon.

Meanwhile, the computing device 1000 may include one or more cameras 1018, one or more sensors 1020, and/or a power system 1022.

The camera(s) 1018 may capture light and/or electromagnetic radiation emitted as visible light, infrared radiation, ultraviolet light, and/or one or more other frequencies of light. The sensor 1020 may be configured to measure conditions within the computing device 1000 and/or conditions in the environment of the computing device 1000 and provide data regarding these conditions. The power system 1022 may include one or more batteries 1024 and/or one or more external power interfaces 1026 to provide power to the computing device 1000.

Meanwhile, the above description explains the implementation of the denoising system 100 of the present invention as a computing device, but the present invention is not limited thereto. For example, the functionality of the neural network and/or computing device may be distributed among a plurality of computing clusters.

Further, the present invention described above may be implemented as a program executed by one or more processes in an electronic device and stored on a computer-readable recording medium.

Therefore, the present invention may be implemented as computer-readable code or instructions on a medium in which the program is recorded. That is, the various control methods according to the present invention may be provided in the form of a program, either in an integrated or individual manner.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A denoising method using a denoising system, the method comprising:
receiving a target image;
generating a rendered image corresponding to the target image based on pre-provided initial scene parameters;
calculating denoising weights based on the target image, and generating a refined image by removing noise from at least one of the rendered image and a gradient of a loss for the rendered image based on the denoising weights; and
calculating a loss between the target image and the refined image, and updating the scene parameters based on a gradient of the calculated loss.

2. The denoising method of claim 1, further comprising:
performing repeatedly, based on the updated scene parameters, from the generating of the rendered image to the updating of the scene parameters, to remove noise from the rendered image.

3. The denoising method of claim 1, wherein, in the generating of the refined image, the refined image corresponding to the rendered image is locally approximated using a linear function for pixel colors of the target image.

4. The denoising method of claim 3, wherein, in the generating of the refined image, a color at a central pixel of the refined image and a result of a first derivative of the color at the central pixel of the refined image are estimated using a weighted least-squares objective function based on pixel colors of each of the target image and the rendered image, along with the denoising weights.

5. The denoising method of claim 1, wherein the denoising weight is determined to represent an importance according to a squared error of a color at an arbitrary pixel of the target image.

6. The denoising method of claim 1, wherein the updating of the scene parameters includes:
calculating the gradient of the loss for the rendered image at an arbitrary pixel based on the refined image through a linear smoother for the rendered image; and
specifying scene parameters that minimize the loss based on the gradient of the loss for the rendered image.

7. The denoising method of claim 6, wherein the specifying of the scene parameters includes:
calculating the gradient of the loss for the scene parameters using a chain rule based on the gradient of the loss for the rendered image; and
specifying the scene parameters that minimize the loss according to the gradient of the loss for the scene parameters.

8. The denoising method of claim 1, wherein the rendered image is an image rendered with a predetermined number of samples to be differentiable based on the scene parameters.

9. A denoising system, comprising:
an input unit configured to receive a target image; and
a control unit configured to generate a rendered image corresponding to the target image based on pre-provided initial scene parameters,
wherein the control unit configured to:
calculate denoising weights based on the target image;
generate a refined image by removing noise from at least one of the rendered image and a gradient of a loss for the rendered image based on the denoising weights;
calculate a loss between the target image and the refined image; and
update the scene parameters based on a gradient of the calculated loss.

10. A program stored on a computer-readable recording medium, and executed by one or more processes in an electronic device, in a denoising method using a denoising system the program comprising instructions to allow the program to perform:
receiving a target image;
generating a rendered image corresponding to the target image based on pre-provided initial scene parameters;
calculating denoising weights based on the target image, and generating a refined image by removing noise from at least one of the rendered image and a gradient of a loss for the rendered image based on the denoising weights; and
calculating a loss between the target image and the refined image, and updating the scene parameters based on a gradient of the calculated loss.
